(19) United States
(12) Patent Application Publication
(10) Pub. No.: US 2010/0220500 A1
(43) Pub. Date: Sep. 2, 2010

(54) POWER CONVERTER AND METHOD FOR CONTROLLING POWER CONVERTER

(75) Inventors: Kazuaki MINO, Tokyo (JP); Kazunari ITOH, Tokyo (JP)

Correspondence Address: ROSSI, KIMMS & McDOWELL LLP., 20609 Gordon Park Square, Suite 150, Ashburn, VA, 20147, US

(73) Assignees: FUJI ELECTRIC SYSTEMS CO., LTD., Tokyo (JP); FUJI ELECTRIC HOLDINGS CO., LTD., Kawasaki-ku (JP)

(21) Appl. No.: 12/696,535

(22) Filed: Jan. 29, 2010

(30) Foreign Application Priority Data
Jan. 29, 2009 (JP) 2009-018302
Nov. 5, 2009 (JP) 2009-254275

(51) Int. Cl. H02M 3/335

(52) U.S. Cl. 363/17

(57) ABSTRACT

The invention prevents the voltage change ratio of switching devices of a power converter from exceeding a specified maximum rating, thus avoiding damage in switching devices and an increase in conduction loss. In a power converter having a plurality of switching devices, switching means for switching a control scheme for the switching devices to a phase shift control scheme or a pulse width modulation scheme is provided, whereby the control scheme for the switching devices is switched from the phase shift control scheme to the pulse width modulation scheme in a non-load or light-load state.

### BACKGROUND OF THE INVENTION

The present invention relates to a power converter which achieves a higher efficiency and to a method for controlling such a power converter. More particularly, the invention relates to a converter suitable for use as an isolated DC/DC power converter and to a method for controlling such a power converter.

FIG. 7 shows an example of an ordinary phase shift control scheme for the switching devices in a power converter. In the diagram, reference numbers 1 to 4 represent switching devices S1 to S4 composed of, e.g., metal oxide semiconductor field-effect transistors (MOSFET). Also shown in the diagram are a DC power supply 5, a transformer 6, a phase shift control signal generator 7, a load current detector 8, rectifier diodes 10 to 13, a smoothing inductor 14, a smoothing capacitor 15, and a load 16.

FIG. 8 is a chart of the waveforms at various points for illustrating the operation of the power converter shown in FIG. 7. In this diagram, Gs1 to Gs4 are gate driving voltage waveforms at switching devices S1 to S4, and Vt is a primary winding voltage waveform of the transformer 6.

In the power converter in FIG. 7, the switching devices S1 and S2 are alternately turned on/off by the phase shift control signal generator 7. The switching devices S3 and S4 then undergo phase shifts in response to the on/off timing of the switching devices S1 and S2, and are alternately turned on/off. The voltage time product of the transformer 6, i.e., the output voltage that is applied to the load 16, is regulated by these phase differences. In addition, this power converter carries out zero voltage switching (ZVS) by a phase shift control scheme, and thus reduces switching losses. In contrast with phase shift control, another control scheme, called pulse width modulation (PWM), turns switching devices S1 and S4 or switching devices S2 and S3 on/off at the same time, alternately generates a control signal for switching devices S1 and S4 and a control signal for switching devices S2 and S3, and regulates the output voltage by the pulse width of the control signals. However, ZVS is not possible in this control scheme.

In the case of a light load or no load, the load current value is small. Therefore, in the above phase shift control scheme, immediately after switching device S1, for example, has turned on, the voltage of the switching device S1 remains zero. Hence, when switching device S2 has turned on next, current readily flows to the body diode (not shown in FIG. 7) of the switching device S1, giving rise to the problem of reverse recovery. This problem has also been described in, for example, Japanese Patent Application Laid-open No. 2002-034238, and is well-known in the art.

On the other hand, in cases where the load current value is large, a parasitic capacitance (not shown in FIG. 7) that has been generated within the MOSFET is rapidly charged in parallel with switching device S1. As a result, the voltage of the switching device S1 rises. A current does not flow to the body diode of the switching device S1 at this time, and so reverse recovery does not arise. That is, when a phase shift control scheme is applied at the time of a low load or no load, reverse recovery arises. Moreover, owing to loss at the interior of the MOSFET rises, the efficiency of the power converter decreases.

Because of how it operates, a MOSFET contains therein a body diode positioned between a drain electrode and a source electrode. When the opposing arm is turned on as a forward current is flowing to this body diode, a current in the reverse direction (reverse recovery current) will flow to the body diode. In particular, a MOSFET requires a period of about several hundreds of nanoseconds until it recovers the ability to inhibit a reverse current. Hence, when reverse recovery arises, the loss increases.

Also, the maximum value of the voltage change ratio per unit time (dv/dt) at the rise time in a voltage applied between the drain electrode and the source electrode when the body diode has reverse-recovered is specified for the MOSFET. This is because of the risk of MOSFET breakdown should the time change ratio exceed the specified maximum value. In addition, when the body diode recovers the ability to inhibit a reverse current, the reverse recovery current abruptly changes and the voltage between the drain and the source rises sharply. When this happens, the voltage change ratio (dv/dt) of the body diode exceeds the specified maximum value and a parasitic bipolar transistor acts between the drain and the source, which may ultimately lead to breakdown of the body diode.

The following two methods exist for preventing the voltage change ratio (dv/dt) between the drain and source from exceeding the specified maximum value. The first of these methods is to increase the resistance value of the gate resistance that drives the MOSFET, thus slowing current and voltage changes at the time of reverse recovery. The second method is to suppress the dv/dt by inserting a CR snubber circuit or the like between the drain and the source. However, with either of these approaches, the power loss increases and the conversion efficiency decreases.

Another conceivable approach is to use a high-withstand MOSFET. However, a MOSFET which is capable of withstanding a large voltage change ratio (dv/dt) also has a large on resistance. As a result, this method gives rise to a new problem; namely, an increase in the MOSFET conduction loss.

The hard switching operations are described below while referring to FIG. 9. FIG. 9 shows an output voltage command waveform Vc, a carrier signal waveform Vcr, gate signal waveforms Gs1 to Gs4 for switching devices 1 to 4 shown in FIG. 7, and drain-source voltage waveforms Vs1 to Vs4 for the same switching devices 1 to 4. First, at time t1, switching devices 1 and 4 turn on simultaneously. The current at this time flows over the following path: DC power supply 5→switching device 1→inductor 20→transformer 6→switching device 4→DC power supply 5. A source voltage Ed is then applied to a primary side of the transformer 6. The inductor 20 may be substituted with leakage inductance from the transformer 6. At this time, because switching devices 1 and 4 are both in the on state, the respective voltages Vs1 and Vs4 are zero. The voltages Vs2 and Vs3 of switching devices 2 and 3 are clamped to the DC source voltage [Ed].

Next, at time t2, when switching devices 1 and 4 turn off, the parasitic capacitances of switching devices 1 to 4 (equivalent capacitances which have formed in parallel with the switching devices) resonate with the inductor 20 and inductance components within the circuit. At this point, the voltages Vs1 to Vs4 of the switching devices oscillate about [Ed/2].

At time t3, the gate signals Gs2 and Gs3 of switching devices 2 and 3 turn on simultaneously. The current at this time flows over the following path: DC power supply 5→switching device 3→transformer 6→inductor 20→switching device 2→DC power supply 5. That is, current flows to the transformer 6 in the reverse direction from at time t1. In addition, a reverse voltage [−Ed] is applied to the primary side of the transformer 6.

The switching devices 2 and 3 are in the on state at this time. Therefore, the respective voltages Vs2 and Vs3 are zero. The voltages Vs1 and Vs4 of switching devices 1 and 4 are clamped to the DC source voltage [Ed].

At time t4, all the switching devices turn off in the same way as at time t2. As a result, resonance operation takes place, with the voltages Vs1 to Vs4 of the switching devices oscillating about [Ed/2].

In this way, a positive or negative voltage is applied to the primary side of the transformer 6, and a voltage proportional to the turn ratio thereof is generated on the secondary side. The secondary side voltage of the transformer 6 is rectified by diodes 10, 11, 12 and 13. The high-frequency component included in this secondary side voltage is reduced by means of the inductor 14 and the capacitor 15. In addition, a smoothed DC output voltage can be obtained from either end of the capacitor 15.

The gate signals Gs1 to Gs4 are generated by distributing the signal Vr obtained from comparing the output voltage command waveform Vc with the carrier signal waveform Vcr. The temporal relationship among Gs1 to Gs4 is thus as follows: t1=t3, t2=t4.

Accordingly, at the switching device turn-on time, a voltage is already being applied to the switching device. For this reason, simultaneous with turn on, the above-described power converter consumes the energy that has accumulated in the parasitic capacitance, generating a loss. For example, the parasitic capacitance of switching device 2 is shorted by the turning on of switching device 2 (time t2→time t3). As a result, the energy that had accumulated in the parasitic capacitance is discharged and consumed. This type of operation is repeated each time switching occurs in the respective switching devices.

Here, the loss P for a single switching device which arises due to discharge of the parasitic capacitance may be expressed by formula (1).

P=Cv²fs/2 (1)

In formula (1), C represents the parasitic capacitance of the switching device, v is the switching device voltage that is applied at the turn-on time, and fs is the switching frequency. Hence, the loss increases in proportion to the square of the voltage v at the turn-on time.

At the same time that the switching device 2 turns on, the voltage Vs2 of that device becomes zero. When this happens, the parasitic capacitance of the switching device 1 is rapidly charged. The voltage Vs1 of switching device 1 then rises to [Ed]. At this time, the current which charges the parasitic capacitance of switching device 1 flows over the following path: DC power supply 5→parasitic capacitance of switching device 1→switching device 2→DC power supply 5. Hence, simultaneous with turn-on of the switching device 2, a large current flows to switching device 2, as a result of which the switching loss (turn-on loss) of switching device 2 rises.

In addition, at this time, the large energy that has accumulated in the parasitic capacitance is suddenly charged and discharged. Therefore, the noise generated from the circuit increases, which may give rise to trouble such as the malfunction of other equipment.

On the other hand, in a phase shift control scheme, because switching device 2 turns on immediately after switching device 1 has turned off (actually, switching device 2 turns on following a very brief dead time after switching device 1 has turned off). Under a light load, because the current flowing to the inductor 20 is small, the energy that accumulates in the parasitic capacitance of switching device 1 from when switching device 1 turns off until switching device 2 turns on is also small. Therefore, when switching device 2 turns on at a voltage Vs1 for switching device 1 that is near zero and at a voltage Vs2 for switching device 2 that is near [Ed], the discharge loss and turn-on loss of the above-described parasitic capacitance become large.

Under a heavy load, the current that flows to the inductor 20 becomes large. Accordingly, by switching to a phase shift control scheme, the switching device voltages Vs1 to Vs4 become zero before the switching devices turn on, thus enabling zero voltage switching (soft switching). For this reason, problems like those described above do not arise.

Japanese Patent Application Laid-open No. 2008-312399 discloses a technology called pseudo-resonance in which a switching device is turned on when the voltage at the switching device has reached a minimum value. However, the pseudo-resonance described in this disclosure is targeted at a one-transistor converter for small capacitances which uses only a single switching device. Obtaining a large output power with such a one-transistor converter is difficult.

Also, in a circuit having a full-bridge configuration for a large capacitance, by changing the on-timing of the switching device in the same manner as in Japanese Patent Application Laid-open No. 2008-312399, the voltage time product applied to the transformer differs accordingly to whether it is positive or negative, resulting in magnetization. This leads to the flow of excessive current, giving rise to another problem: equipment failure.

In the power converter described in Japanese Patent Application Laid-open No. 2002-034238, a method of switching from phase shift control to pulse width control is indicated in cases where, in a no-load state or a light-load state, the output voltage rises above a desired voltage. In this method, the primary side is always under pulse-width control, as a result of which reverse recovery of the switching device does not arise. However, the number of switching devices through which the current passes becomes large (the number of devices through which the current passes being especially large on the secondary side), resulting in an increase in the conduction loss.

In view of the above, it would be desirable to provide a power converter which, without increasing the number of switching devices in the power converter, keeps the voltage change ratio (dv/dt) of the switching devices from exceeding a specified maximum value and does not allow the conduction loss to increase.

### SUMMARY OF THE INVENTION

The present invention provides a power converter which, without increasing the number of switching devices in the power converter, keeps the voltage change ratio (dv/dt) of the switching devices from exceeding a specified maximum value and does not allow the conduction loss to increase.

The invention provides switching devices which make up a high-capacitance DC/DC conversion circuit reduce the loss accompanying charge and discharge of the parasitic capacitances generated at the turn-on time, and thereby increase the efficiency of the conversion circuit.

In particular, the invention provides a power converter having a switching device and adapted for connecting an inverter that converts DC input voltage to AC voltage to a rectifying diode through a transformer and feeding power to a load. The power converter includes switching means for setting a control scheme for the switching device to a hard switching scheme when a current flowing to the load is at or below a specific current value, and switching the control scheme for the switching device to a phase shift control scheme when the current flowing to the load exceeds the specific current value.

The switching means may have a load current detector for detecting a current value flowing to the load, a control scheme decision unit for selecting the switching device control scheme based on a magnitude of the load current detected by the load current detector, and a switching device control signal generator for receiving the control scheme selected by the control scheme decision unit and generating a control signal for the switching device.

Further, the invention provides a method for controlling a power converter which carries out hard switching scheme control in a DC/DC conversion circuit that respectively connects in parallel to a DC power source both a first and a second serial circuit in each of which two switching devices are connected in series, connects a first end of a primary winding of a transformer to an internal connection point on the first serial circuit, connects a second end of the primary winding to an internal connection point on the second serial circuit, connects a rectifying device to a secondary winding of a transformer and obtains a DC output, the method including the steps of: setting a first off period in which all switching devices are in an off state after an upper arm switching device in the first serial circuit and a lower arm switching device in the second serial circuit have turned off until a lower arm switching device in the first serial circuit and an upper arm switching device in the second serial circuit turn on; and setting a second off period in which all switching devices are in an off state after the lower arm switching device in the first serial circuit and the upper arm switching device in the second serial circuit have turned off until the upper arm switching device in the first serial circuit and the lower arm switching device in the second serial circuit turn on, such that the first off period and the second off period mutually differ.

The method may also include the step of regulating the switching frequency so that the upper arm switching device in the serial circuit turns on when a voltage of the upper arm switching device in the first or the second serial circuit has approached a minimum value; or regulating the switching frequency so that the lower arm switching device in the serial circuit turns on when a voltage of the lower arm switching device in the first or the second serial circuit has approached a minimum value.

Alternatively, the may also include the step of regulating the first and second off periods so that the upper arm switching device in the serial circuit turns on when a voltage of the upper arm switching device in the first or the second serial circuit has approached a minimum value; or regulating the first and second off periods so that the lower arm switching device in the serial circuit turns on when a voltage of the lower arm switching device in the first or the second serial circuit has approached a minimum value.

Furthermore, the a capacitor may also be connected between the internal connection point on the first or second serial circuit and the transformer; and selecting a timing at which the upper arm (or lower arm) switching device turns on such that the upper arm (or lower arm) switching device in the serial circuit turns on when a voltage of the upper arm (or lower arm) switching device in the first or second serial circuit has approached a minimum value, and the lower arm (or upper arm) switching device in the serial circuit turns on when a voltage of the lower arm (or upper arm) switching device in the first or second serial circuit has approached a minimum value.

In a further preferred embodiment, at least one from among the on timing, off timing and switching frequency of the switching device may be altered according to an output power magnitude and an output current magnitude, and regulated such that the switching device turns on when a voltage of the switching device has approached a minimum value.

In a still further preferred embodiment, control may be carried out when an output power is at or below a specific value, and such control may be carried out by a phase shift scheme when the output power exceeds the specific value.

The present invention makes it possible, without increasing the number of switching devices in a power converter, for the converter to keep the voltage change ratio (dv/dt) of the switching devices from exceeding a specified maximum value, thus avoiding an increase in conduction loss.

Moreover, the invention also makes it possible, in a DC/DC conversion circuit having a full-bridge configuration for large capacitance, to reduce loss associated with the charge/discharge of parasitic capacitance that arises when the switching devices are turned on, thereby enabling a higher conversion circuit efficiency to be achieved. In conversion circuits which employ the present invention, owing to the reduction in loss, it is possible to reduce the size of cooling fins and lower costs. Moreover, because the present invention reduces the energy of parasitic capacitance charge/discharge during switching, the noise generated can be reduced.

### BRIEF DESCRIPTION OF THE DRAWINGS

The invention will be described with reference to certain preferred embodiments thereof and the accompanying drawings, wherein:

FIG. 1 is a circuit diagram showing a first embodiment of the invention;

FIG. 2 is a chart of waveforms at various points on the circuit shown in FIG. 1 during circuit operation;

FIG. 3 is a chart of waveforms at various points illustrating another embodiment of the invention;

FIG. 4 is a chart of waveforms at various points illustrating a further embodiment of the invention;

FIG. 5 is a circuit diagram showing a still further embodiment of the invention;

FIG. 6 is a chart of waveforms at various points illustrating another embodiment of the invention;

FIG. 7 is a circuit diagram illustrating an example from the related art;

FIG. 8 is a chart of waveforms at various points for illustrating operation of the circuit in FIG. 7; and

FIG. 9 is a chart of waveforms at various points for illustrating operation of a PWM scheme.

### DESCRIPTION OF THE PREFERRED EMBODIMENTS

### Embodiment 1

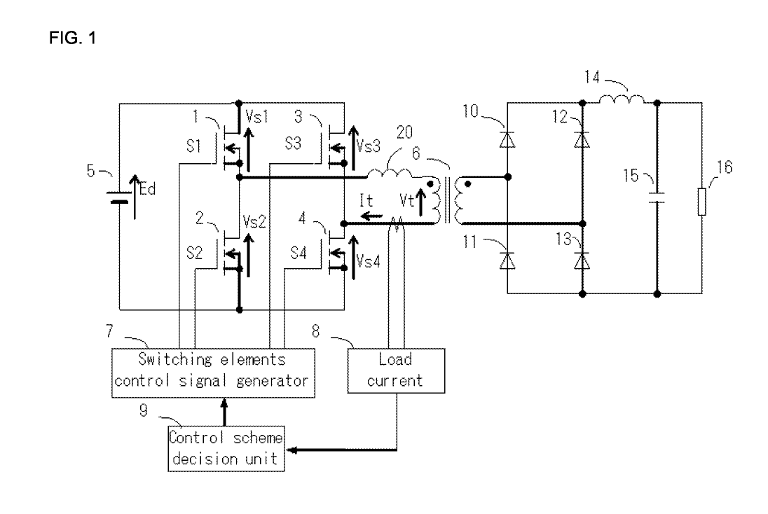

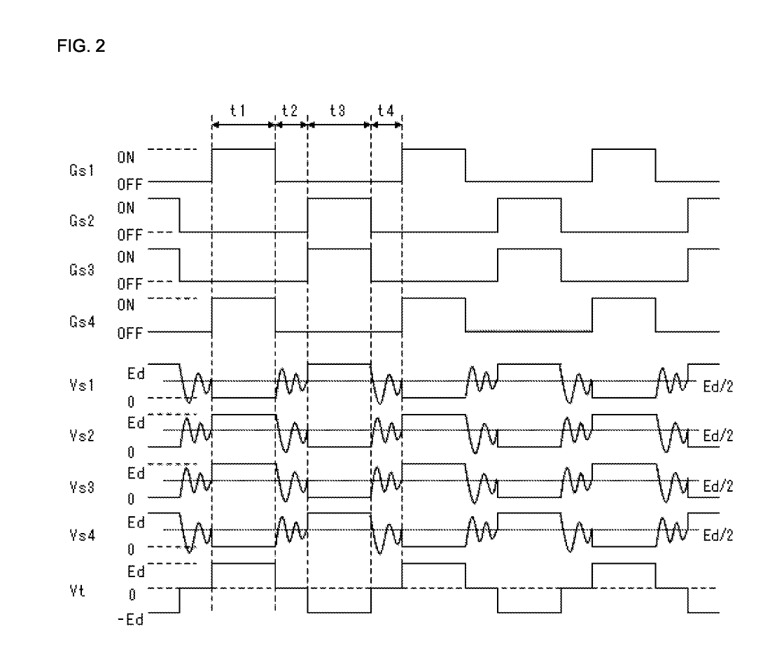

FIG. 1 is a circuit diagram illustrating a first embodiment of the present invention, and FIG. 2 is a chart of waveforms at various points for illustrating the operation of the same circuit.

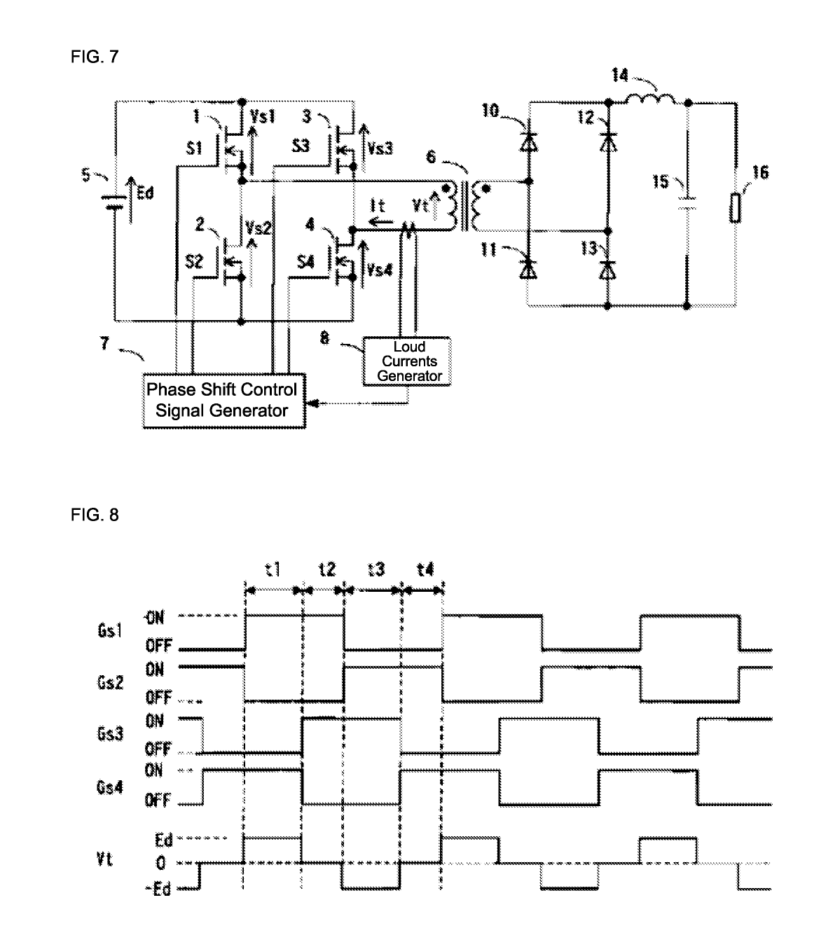

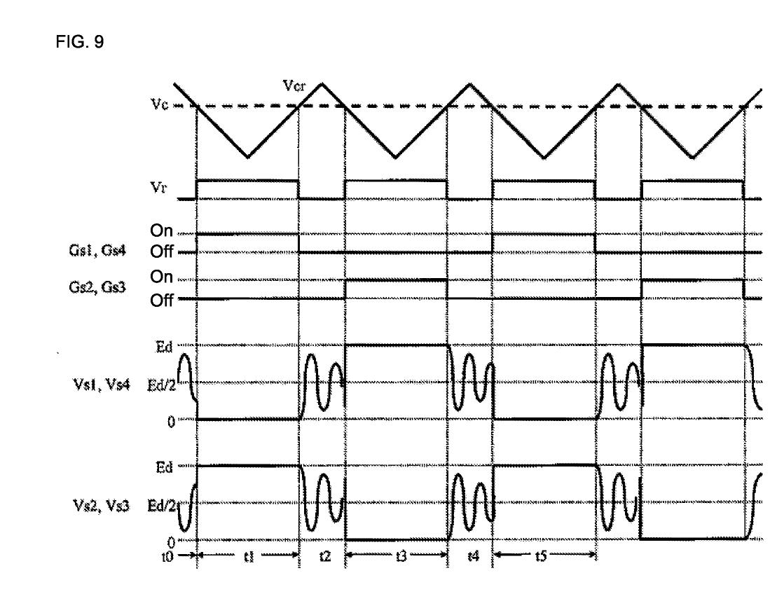

In FIG. 1, elements having the same function as those in FIG. 7 showing a conventional power converter are denoted by the same reference symbols, and explanations of those elements are omitted. The first embodiment of the present invention differs from the power converter of FIG. 7 in that it is provided with a switching device control signal generator 7A and a control scheme decision unit 9.

GS1 to Gs4 in FIG. 2 are the gate driving voltage waveforms for switching devices S1 to S4 shown in FIG. 1, Vs1 to VS4 are the drain-source voltage waveforms for switching devices S1 to S4, and Vt is a primary winding voltage waveform for the transformer 6.

The switching devices S1 to S4 are driven by gate signals generated by the switching device control signal generator 7A. As a result, the DC voltage of the DC power supply 5 is converted to AC voltage and applied to the primary side winding of the transformer 6. The alternating current that arises in the secondary side winding of the transformer 6 is rectified to direct current by the diodes 10 to 13. This direct current is smoothed by a smoothing circuit composed of an inductor 14 and a capacitor 15, and fed to a load 16. Here, the power converter shown in FIG. 1 (DC/DC converter) differs from the power converter shown in FIG. 7 in that the control scheme for the primary side switching devices S1 to S4 is switched in accordance with the output current value (load current value). Hence, the present invention is configured in such a way that the primary side current value in the transformer 6 is detected with a load current detector 8 and input to the control scheme decision unit 9.

FIG. 2 shows the voltage waveforms at the switching devices when the current flowing to the load 16 has been detected as being at or below a specific current value, i.e., when the load current is a light load or no load, and control of the switching devices S1 to S4 has been switched to a PWM scheme.

That is, at time t1, switching devices S1 and S4 turn on and the current flows over the following path: S1→inductor 20→transformer 6→S4. At this time, the voltage Vt on the primary side winding of the transformer 6 becomes [+Ed]. At time t3, switching devices S2 and S3 turn on and the current flows over the following path: switching device S3→transformer 6→inductor 20→switching device S2. That is, the current flows in the reverse direction to time t1. At this time, the voltage Vt on the primary side winding of the transformer 6 becomes [−Ed].

At time t2 and time t4, all of the switching devices S1 to S4 are turned off. At these times, the voltages at switching devices S1 to S4 oscillate about [Ed/2] due to resonance between the parasitic capacitances at S1 to S4 and the inductor 20. When the power fed to the load 16 is large, i.e., at a heavy load where the ratio of the load current value to the rated current value is 100%, 75% or 50%, the load current value detected at the load current detector 8 is large. Hence, the control scheme detection unit 9 selects the phase shift scheme. The control signal generator 7A decides how much to shift the phase of the reference pulse in accordance with the current value that is detected, and carries out on/off control of the switching devices S1 to S4.

On the other hand, when the power fed to the load 16 is small, i.e., at a light load when the ratio of the load current value to the rated current value is 10% or 20%, or in a no-load state, the load current value detected at the load current detector 8 is small. The control scheme decision unit 9 thus selects the PWM scheme, and sends a signal to the control signal generator 7A indicating that the PWM scheme was selected.

In the PWM scheme, the period in which the switching devices S1 to S4 (MOSFETs) are all in an off state is long. During off state, switching devices S1 and S2 and switching devices S3 and S4, depending on the ratios of the parasitic capacitances held by each, oscillate about ½ the DC power supply 5 voltage [Ed] (when the parasitic capacitances of the switching devices S1 to S4 are the same) owing to resonance with the inductor 20.

By adding the positive voltage [Ed/2] (excluding the oscillating component) between the drain and source of each MOSFET of switching devices S1 to S4, a state wherein reverse voltage has been added to the body diode (not shown in FIG. 1) within each MOSFET is maintained. Hence, the reverse-direction voltage added to the body diode does not fall below 0 V. For this reason, forward current does not flow to the body diode; nor does a reverse recovery current arise. Even if a hard switching operation does arise according due to the PWM scheme at a light-load or no-load time, because the current value is small, the increase in switching loss, such as turn-on loss and turn-off loss, is minimal.

That is, because the power converter control scheme according to the present invention has been configured so as switch from a Phase shift control scheme to a pulse width modulation scheme at a light-load time or no-load time, the reverse recovery current generated in a phase shift scheme can be suppressed. Therefore, the present invention is able to achieve a higher power converter efficiency without generating a reverse recovery and in particular without increasing the number of switching devices.

On the other hand, if a phase shift control scheme is employed at a light-load time, as explained above, switching device 2 turns on when the voltage Vs1 of switching device 1 is near zero and the voltage Vs2 of switching device 2 is near [Ed]. Yet, upon conversion to the PWM scheme, because all the off periods become longer, when switching device 2 is on, the voltage Vs1 of switching device 1 rises above a near-zero value and the voltage Vs2 of switching device 2 falls below a near-[Ed] value. As a result, the discharge loss of parasitic capacitance when the switching device 2 is on can be reduced. In addition, when switching device 2 is on, the current (which flows over the following path: DC power supply 5→switching device 1 parasitic capacitance→switching device 2→DC power supply 5) which charges the parasitic capacitance of switching device 1 up to [Ed] also decreases, thus enabling a reduction in the switching device 2 turn-on loss as well.

In the power converter control scheme according to the present invention, the switching device control signal generator 7A and the control scheme decision unit 9 can be suitably created using, for example, hardware equipment or microcomputers. Also, in the above-described embodiment, the load current value was detected as the current which flows to the primary side of the transformer 6, although it may of course be detected instead as the current which flows to the secondary side of the transformer 6.

### Embodiment 2

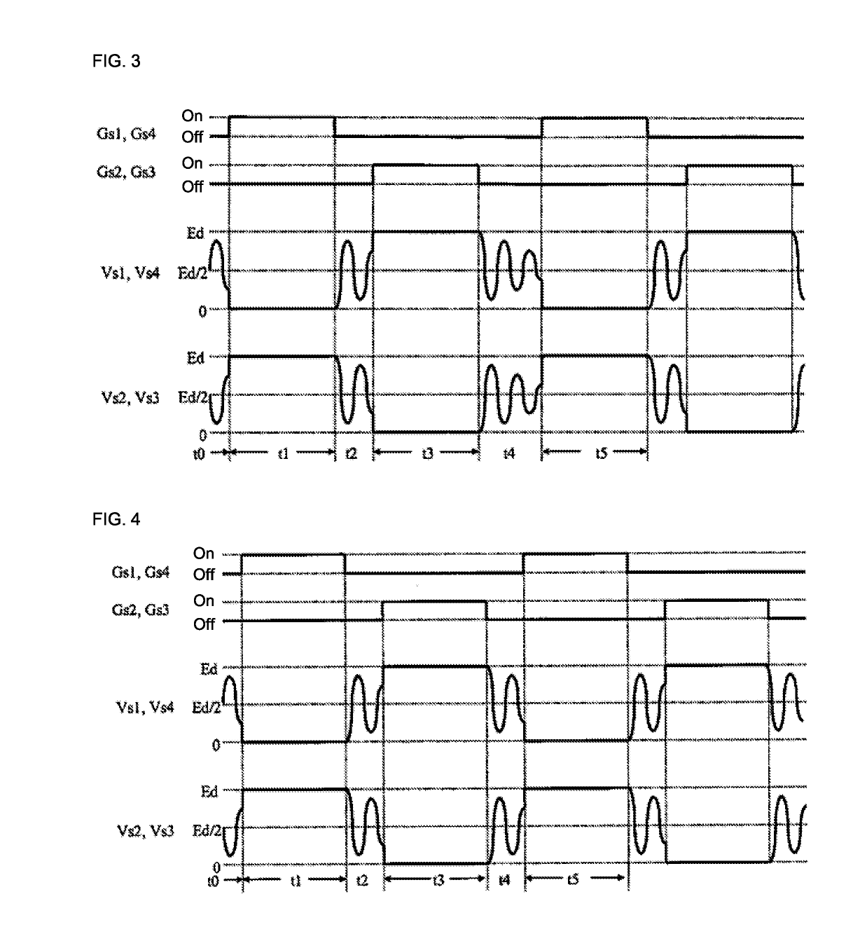

FIG. 3 is a chart of waveforms at various points for illustrating a second embodiment according to the present invention. The circuit configuration is the same as in FIG. 7.

FIG. 3 shows an embodiment in which the times t2 and t4 when all the switching devices are off was regulated, and the switching devices were set so as to turn on when the switching device voltage had approached a minimum value. For example, the on timing of switching device 2 is regulated so that the switching device 2 turns on when the voltage Vs2 has approached a minimum value. However, if the positive side and negative side voltage time products applied to the transformer are not equal, the transformer magnetizes and excess current flows, damaging the circuit device. Hence, the on timing of switching device 2 must be regulated with condition t1=t3 being satisfied.

Accordingly, the sum of time t2 and time t4 is set constant and the ratio between times t2 and t4 is regulated. For example, if the on timing of switching device 2 is advanced, the off timing must be advanced by exactly the same amount of time in order to avoid a magnetic saturation. In this way, the voltage of the switching device at the turn-on time can be adjusted to be small. For this reason, as is apparent also from formula (1), the energy that has accumulated in the parasitic capacitance of the switching device 2 becomes small. Also, the loss consumed at the turn-on time decreases.

At the same time, the voltage Vs1 of the switching device 1 varies as shown in formula (2) below. That is, when the voltage Vs2 is a minimum, the voltage Vs1 becomes a maximum.

Vs1=Ed−Vs2 (2)

In other words, when the voltage Vs2 is a minimum, the difference between [Ed] and [Vs1] becomes small. As a result, the current (which flows over the following path in FIG. 7: DC power supply 11→switching device 1 parasitic capacitance→switching device 2→DC power supply 11) that charges the parasitic capacitance at switching device 1 when switching device 2 is turned on becomes small. Also, turn-on loss at the switching device 2 is reduced.

Because the energy of the parasitic capacitance that charges/discharges at the turn-on time can be reduced, noise generation can be suppressed. The inventive method for controlling a power converter thus enables operation to be carried out without adversely affecting other equipment.

In the present embodiment, the ratio between times t2 and t4 is altered by shifting the on timing and off timing of the switching device 2. However, in the inventive method for controlling a power converter, operation may be similarly carried out even by shifting the control timing of another switching device.

### Embodiment 3

FIG. 4 shows a chart of operation waveforms corresponding to claim 4. In this Embodiment 3, the switching frequency is regulated in such a way that a switching device turns on when the voltage of the switching device approaches a minimum value. For example, when the switching frequency is made high, each of the times t0 to t5 becomes short; conversely, when the switching frequency is made low, each of the times t0 to t5 becomes long. However, the resonance period of the switching device voltage at times t2 and t4 when the switching devices are off is determined by the circuit constant or the parasitic component, and is fixed. Therefore, by regulating the switching frequency, it is possible to regulate the turn-on timing in such a way that the switching device turns on when the switching device voltage approaches a minimum value. As a result, actions and effects similar to those in Embodiment 2 are achieved.

### Embodiment 4

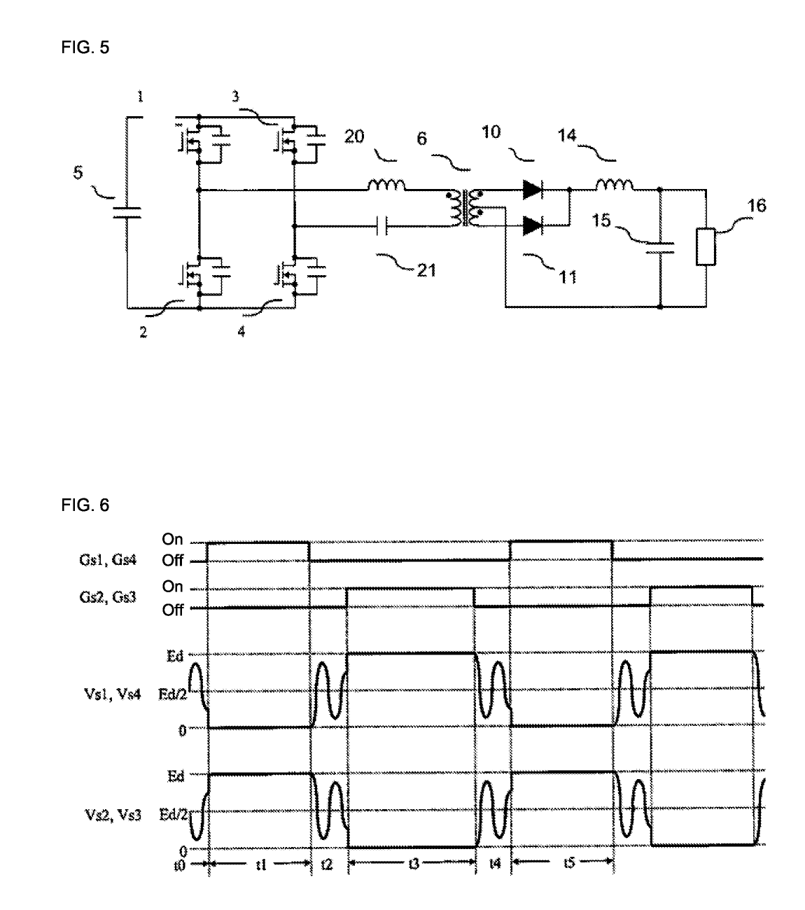

FIG. 5 shows an example of a main circuit according to this invention, and FIG. 6 shows an operation waveform chart for illustrating another embodiment of this invention. FIG. 6 is a diagram showing an example in which, by regulating the on periods of switching devices 1 and 4 shown in FIG. 7, control was carried out so as to achieve actions and effects similar to those in Embodiment 2. For example, switching device 2 is turned on at a timing where the voltage Vs2 becomes a minimum, along with which the timing at which switching device 2 turns off is regulated so that the switching device 1 turns on when the voltage Vs1 of switching device 1 becomes a minimum. However, the control signal for switching device 1 at this time is not regulated.

In this case, because the on timing and off timing of switching device 2 are both regulated, the control pulse width of switching device 2 changes and the lengths of times t1 and t3 do not agree, creating the possibility of transformer magnetization. Hence, as shown in FIG. 5, a capacitor 21 is inserted on the primary side of the transformer 6 so as to eliminate the DC component of the primary side voltage in the transformer 6. In this way, the circuit device can be safely operated without magnetization of the transformer.

This embodiment, by shifting the on timing and off timing of switching device 2, arranges for the respective switching devices to turn on when the voltage Vs1 of switching device 1 and the voltage Vs2 of switching device 2 become minimum values. In this embodiment, similar operation occurs even when the on timing and off timing of another switching device 2 are shifted, resulting in similar effects.

To keep the output voltage constant even when the output power and output current fluctuate, it is necessary to vary what may be referred to as the “conduction ratio,” that is, the ratio between the times t1, t3 and t5 when the switching devices are on and the times t2 and t4 when they are off. Hence, in the present embodiment, even when the conduction ratio varies with changes in the output power or output current, because the on timing is changed so that the switching device voltage approaches a minimum value as provided for in claim 7, higher efficiency and lower noise can be achieved over a broad operating range. Such control can easily be achieved by digital control; that is, by storing in the power converter as precontrolled variables an on timing regulation variable and a switching frequency change variable. The inventive method for controlling a power converter is thus capable of carrying out control, with specific regulation variables, according to the detected values for output power and output current.

In the present embodiment, as in Embodiment 1, at the time of a heavy load, soft switching is achieved by carrying out phase shift operation, and at the time of a light load, a PWM scheme is carried out. In this way, operation can be safely carried out without exceeding the limit value for the voltage change ratio (dv/dt). Moreover, by applying this invention, not only is it possible to reduce loss in a PWM scheme at the time of a light load, loss over a broad load range can also be reduced.

The regulation of on timing and off timing is readily achievable by, for example, the use of ordinary digital control and shift registers.

The invention has been described with reference to certain preferred embodiments thereof. It will be understood, however, that modifications and variations are possible within the scope of the appended claims.

What is claimed is:

1. A power converter having a switching device and adapted for connecting an inverter that converts DC input voltage to AC voltage to a rectifying diode through a transformer and feeding power to a load, comprising:
switching means for setting a control scheme for the switching device to a pulse width modulation scheme when a current flowing to the load is at or below a specific current value, and switching the control scheme for the switching device to a phase shift control scheme when the current flowing to the load exceeds the specific current value.

2. The power converter according to claim 1, wherein the switching means comprises:
a load current detector for detecting a current flowing to the load;
a control scheme decision unit for selecting the switching device control scheme based on a magnitude of the load current detected by the load current detector; and
a switching device control signal generator for receiving the control scheme selected by the control scheme decision unit and generating a control signal for the switching device.

3. A method for controlling a power converter, which carries out pulse width modulation scheme control in a DC/DC conversion circuit that respectively connects in parallel to a DC power source both a first and a second serial circuit in each of which two switching devices are connected in series, connects a first end of a primary winding of a transformer to an internal connection point on the first serial circuit, connects a second end of the primary winding to an internal connection point on the second serial circuit, connects a rectifying device to a secondary winding of the transformer and obtains a DC output, the method comprising the steps of:
setting a first off period in which all switching devices are in an off state after an upper arm switching device in the first serial circuit and a lower arm switching device in the second serial circuit have turned off until a lower arm switching device in the first serial circuit and an upper arm switching device in the second serial circuit turn on; and
setting a second off period in which all switching devices are in an off state after the lower arm switching device in the first serial circuit and the upper arm switching device in the second serial circuit have turned off until the upper arm switching device in the first serial circuit and the lower arm switching device in the second serial circuit turn on, such that the first off period and the second off period mutually differ.

4. The method for controlling a power converter according to claim 3, further comprising the step of:
regulating a switching frequency so that the upper arm switching device in the serial circuit turns on when a voltage of the upper arm switching device in the first or second serial circuit has approached a minimum value; or
regulating a switching frequency so that the lower arm switching device in the serial circuit turns on when a voltage of the lower arm switching device in the first or second serial circuit has approached a minimum value.

5. The method for controlling a power converter according to claim 3, further comprising the step of:
regulating the first and second off periods so that the upper arm switching device in the serial circuit turns on when a voltage of the upper arm switching device in the first or second serial circuit has approached a minimum value; or
regulating the first and second off periods so that the lower arm switching device in the serial circuit turns on when a voltage of the lower arm switching device in the first or second serial circuit has approached a minimum value.

6. The method for controlling a power converter according to claim 3, further comprising the steps of:
connecting a capacitor between the internal connection point on the first or second serial circuit and the transformer; and
selecting a timing at which the upper arm (or lower arm) switching device turns on such that the upper arm (or lower arm) switching device in the serial circuit turns on when a voltage of the upper arm (or lower arm) switching device in the first or second serial circuit has approached a minimum value, and the lower arm (or upper arm) switching device in the serial circuit turns on when a voltage of the lower arm (or upper arm) switching device in the first or second serial circuit has approached a minimum value.

7. The method for controlling a power converter according to claim 3, further comprising the step of altering at least one from among the on timing, off timing and switching frequency of the switching device according to an output power magnitude and an output current magnitude, and carrying out regulation such that the switching device turns on when a voltage of the switching device has approached a minimum value.

8. The method for controlling a power converter according to claim 4, further comprising the step of altering at least one from among the on timing, off timing and switching frequency of the switching device according to an output power magnitude and an output current magnitude, and carrying out regulation such that the switching device turns on when a voltage of the switching device has approached a minimum value.

9. The method for controlling a power converter according to claim 5, further comprising the step of altering at least one from among the on timing, off timing and switching frequency of the switching device according to an output power magnitude and an output current magnitude, and carrying out regulation such that the switching device turns on when a voltage of the switching device has approached a minimum value.

10. The method for controlling a power converter according to claim 6, further comprising the step of altering at least one from among the on timing, off timing and switching frequency of the switching device according to an output power magnitude and an output current magnitude, and carrying out regulation such that the switching device turns on when a voltage of the switching device has approached a minimum value.

11. A method for controlling a power converter, comprising the step of carrying out the control of claim 3 when an output power is at or below a specific value, and carrying out control by a phase shift scheme when the output power exceeds the specific value.

12. A method for controlling a power converter, comprising the step of carrying out the control of claim 4 when an output power is at or below a specific value, and carrying out control by a phase shift scheme when the output power exceeds the specific value.

13. A method for controlling a power converter, comprising the step of carrying out the control of claim 5 when an output power is at or below a specific value, and carrying out control by a phase shift scheme when the output power exceeds the specific value.

14. A method for controlling a power converter, comprising the step of carrying out the control of claim 6 when an output power is at or below a specific value, and carrying out control by a phase shift scheme when the output power exceeds the specific value.

15. A method for controlling a power converter, comprising the step of carrying out the control of claim 7 when an output power is at or below a specific value, and carrying out control by a phase shift scheme when the output power exceeds the specific value.

16. A method for controlling a power converter, comprising the step of carrying out the control of claim 8 when an output power is at or below a specific value, and carrying out control by a phase shift scheme when the output power exceeds the specific value.

17. A method for controlling a power converter, comprising the step of carrying out the control of claim 9 when an output power is at or below a specific value, and carrying out control by a phase shift scheme when the output power exceeds the specific value.

18. A method for controlling a power converter, comprising the step of carrying out the control of claim 10 when an output power is at or below a specific value, and carrying out control by a phase shift scheme when the output power exceeds the specific value.
